(19) United States
(12) Patent Application Publication
(10) Pub. No.: US 2025/0392677 A1
(43) Pub. Date: Dec. 25, 2025

(54) IMAGE PROCESSING DEVICE, IMAGE FORMING APPARATUS, AND IMAGE PROCESSING METHOD

(71) Applicant: Yuuki SAGIMORI, Kanagawa (JP)

(72) Inventor: Yuuki SAGIMORI, Kanagawa (JP)

(73) Assignee: Ricoh Company, Ltd., Tokyo (JP)

(21) Appl. No.: 19/230,719

(22) Filed: Jun. 6, 2025

(30) Foreign Application Priority Data
Jun. 21, 2024 (JP) 2024-100195

(51) Int. Cl. H04N 1/60; G03G 15/01

(52) U.S. Cl. CPC H04N 1/6027; G03G 15/0131; H04N 1/6019

(57) ABSTRACT

An image processing apparatus includes circuitry configured to convert input data of a plate without a special color plate into grayscale to obtain a first gradation value of a black plate, the special color plate being a plate excluding the black plate, a magenta plate, a cyan plate, and a yellow plate; generate special color plate data having a second gradation value of the special color plate based on the first gradation value of the black plate; and output output data, generated based on the special color plate data, to an image former to form a print image on a medium.

### CROSS-REFERENCE TO RELATED APPLICATIONS

This patent application is based on and claims priority pursuant to 35 U.S.C. § 119 (a) to Japanese Patent Application No. 2024-100195, filed on Jun. 21, 2024, in the Japan Patent Office, the entire disclosure of which is hereby incorporated by reference herein.

### BACKGROUND

### Technical Field

The present disclosure relates to an image processing device, an image forming apparatus incorporating the image processing device, and an image processing method.

### Related Art

In an image forming apparatus that outputs using process colors Cyan, Magenta, Yellow, and Black (CMYK), along with special colors such as silver, an image processing technique is known for performing monochrome printing using Black and silver (K+silver).

### SUMMARY

An embodiment of the present disclosure provides an image processing apparatus including circuitry configured to convert input data of a plate without a special color plate into grayscale to obtain a first gradation value of a black plate, the special color plate being a plate excluding the black plate, a magenta plate, a cyan plate, and a yellow plate; generate special color plate data having a second gradation value of the special color plate based on the first gradation value of the black plate; and output output data, generated based on the special color plate data, to an image former to form a print image on a medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image forming apparatus according to a first embodiment;

FIG. 2 is a diagram illustrating a relationship between a gradation and a brightness of output data of the image forming apparatus in FIG. 1;

FIG. 3 is a diagram illustrating a hardware configuration of an image forming apparatus in FIG. 1;

FIG. 4 is a diagram illustrating a hardware configuration of a digital front end (DFE) according to a first embodiment;

FIG. 5 is a diagram illustrating a functional configuration of the DFE in FIG. 4;

FIG. 6 is a diagram illustrating a tone reproduction curve (TRC) for gradation correction, used in the DFE of FIG. 4;

FIG. 7 is a diagram illustrating a setting screen of the DFE in FIG. 4;

FIG. 8 is a diagram illustrating a setting screen of the DFE in FIG. 4;

FIG. 9 is a diagram illustrating a process for generating output data for a K+silver plate of the DFE in FIG. 4;

FIG. 10 is a diagram illustrating a functional configuration of a DFE according to a second embodiment;

FIG. 11 is a diagram illustrating a lookup table (LUT) used in the DFE of FIG. 10; and

FIG. 12 is a diagram illustrating a process for generating output data for a K+silver plate of the DFE in FIG. 12.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

As a technique related to printing using silver, a configuration has been disclosed in a printing apparatus that produces glossy printed materials by adding special colors such as silver or gold to the basic colors Cyan, Magenta, Yellow, and Black (CMYK). This configuration identifies the gloss components by calculating the component values of the basic colors that reproduce the gloss of the printed material and those of the special colors.

In an image forming apparatus that outputs using CMYK process colors along with special colors such as silver, glossy monochrome printing using a silver plate requires the print data to include the silver plate in advance. However, typical techniques require creating a silver plate to be used in the print data and adjusting the black plate based on the output characteristics of the image forming apparatus to achieve the intended print result.

According to one aspect of the present disclosure, a desired glossy output using a silver plate in addition to a black plate can be obtained without empirically adjusting the gradation of each color.

An image projection apparatus, an image processing device, an image forming apparatus, and an image forming method are described below in detail with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### First Embodiment

### Overview of Configuration and Operation of Image Forming Apparatus

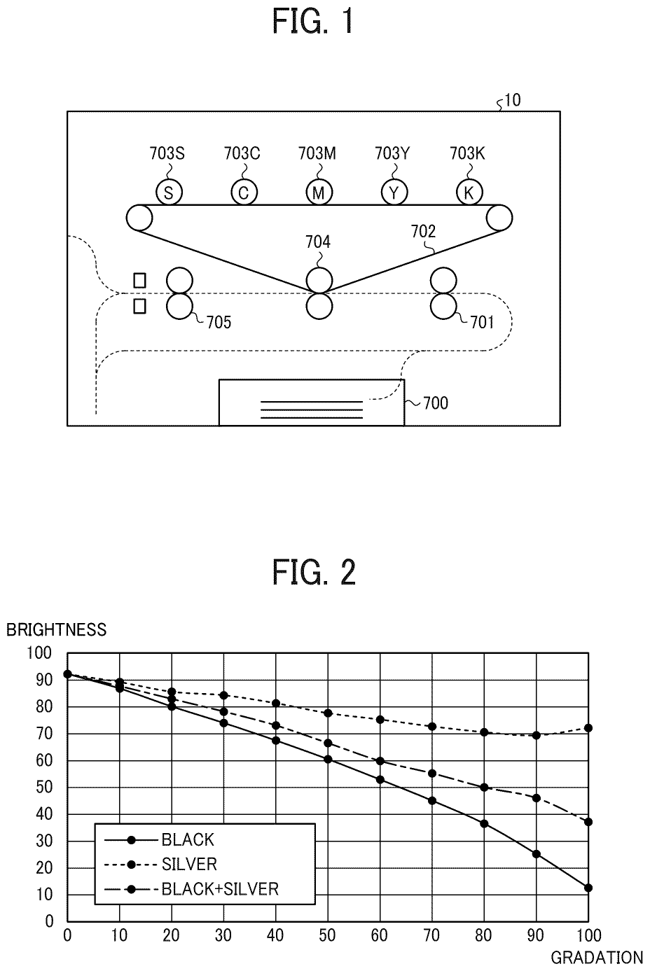

FIG. 1 is a diagram illustrating a configuration of an image forming apparatus 10 according to a first embodiment. FIG. 2 is a diagram illustrating a relationship between a gradation and a brightness of output data of the image forming apparatus according to the first embodiment. The overview of the structure of the image forming apparatus 10 according to the embodiment is described with reference to FIGS. 1 and 2.

As illustrated in FIG. 1, the image forming apparatus 10 is, for example, a tandem-type printer, and includes a sheet feeding tray 700, a conveyance roller 701, an intermediate transfer belt 702, photoconductor drums 703C, 703M, 703Y, 703K, and 703S, a transfer roller 704, and a fixing roller 705.

The sheet feeding tray 700 is a tray in which recording media such as sheets of paper to be fed are stored. The conveyance roller 701 is a pair of rollers that convey a recording medium fed from the sheet feeding tray 700 to the transfer roller 704 along a conveyance path.

The intermediate transfer belt 702 is an endless belt on which an intermediate transfer image is formed by the photoconductor drums 703C, 703M, 703Y, 703K, and 703S.

The photoconductor drum 703C is a photoconductor drum that forms a cyan toner image on the intermediate transfer belt 702. The photoconductor drum 703M is a photoconductor drum that forms a magenta toner image on the intermediate transfer belt 702. The photoconductor drum 703Y is a photoconductor drum that forms a yellow toner image on the intermediate transfer belt 702. The photoconductor drum 703K is a photoconductor drum that forms a black toner image on the intermediate transfer belt 702. The photoconductor drum 703S is a photoconductor drum that forms a special color toner image on the intermediate transfer belt 702. In the present disclosure, the special color refers to a color produced by a metallic color material with a metallic luster, such as gold or silver toner, or by a brilliant color material, such as pearl or mica. In the present embodiment, silver is used as an example. The photoconductor drums 703C, 703M, 703Y, 703K, and 703S are simply referred to as “photoconductor drum 703” when any photoconductor drum is indicated or when they are collectively referred to. With respect to the photoconductor drum 703, colors of C, M, Y, and K are applied as process colors, however, colors of C, M, and Y may be used as the process colors, or R (red), B (blue), and G (green) may be used as the process colors in alternative to the colors of C, M, and Y.

The transfer roller 704 is a roller that transfers the full-color or monochrome image (intermediate transfer image) formed on the intermediate transfer belt 702 onto the recording medium conveyed by the conveyance roller 701. By the function of the transfer roller 704, the full-color or monochrome image is formed (printed) on the recording medium.

The fixing roller 705 is a roller for fixing an image on a recording medium on which a full-color image has been formed.

Typically, the Lab color space is designed to approximate human vision, and the L component value (i.e., luminance component) of the Lab color space is very close to human perception of brightness. Even when a monochrome image is printed in black and silver, if its luminance varies linearly, the resulting image aligns with human perception and appears natural. However, the combination of black and white gradations is not uniquely determined when the brightness component is varied linearly. FIG. 2 presents the brightness characteristics with respect to gradation in the cases of black monochrome, silver monochrome, and a combination of black and silver. As illustrated in FIG. 2, in the case of the silver monochrome, the brightness decreases only to about 70 at most, resulting in an overall bright image. However, adding black to silver allows the brightness to decrease to as low as approximately 40. Accordingly, in the image forming apparatus 10 according to the present embodiment, silver is primarily used in highlight areas, and starting from the middle gradation range, the amount of black component added is gradually increased, thus forming a printed image in which brightness changes linearly. As a result, as illustrated in FIG. 2, in the combination of black and silver, the brightness decreases linearly and monotonically as the gradation increases, allowing glossiness brought by silver to be maximized.

### Hardware Configuration of Image Forming Apparatus

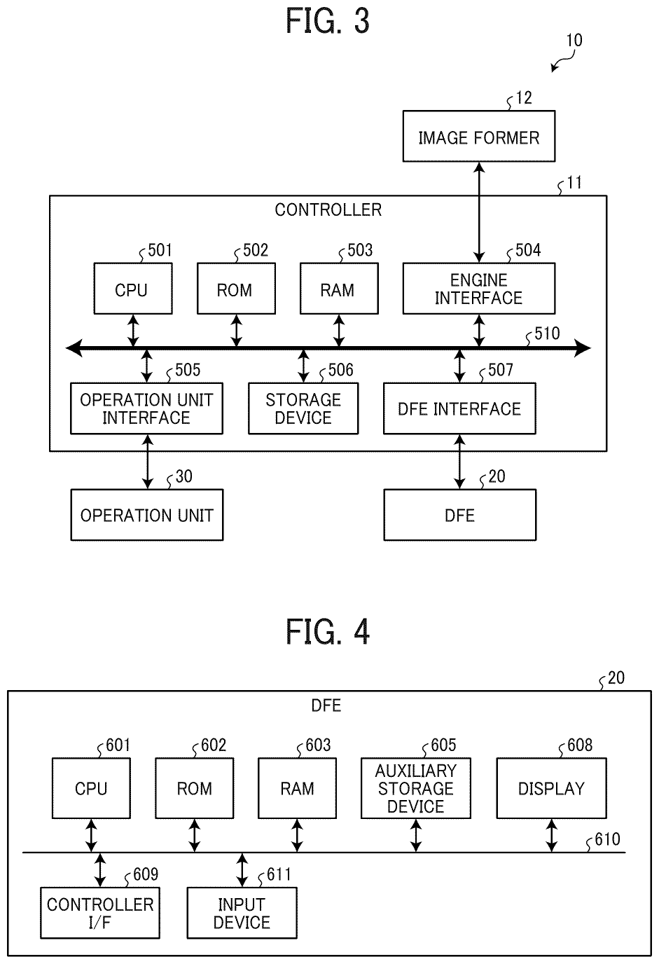

FIG. 3 is a diagram illustrating a hardware configuration of an image forming apparatus according to the first embodiment. The following describes the hardware configuration of the image forming apparatus 10 according to the present embodiment, with reference to FIG. 3.

As illustrated in FIG. 3, the image forming apparatus 10 includes a controller 11 and an image former 12.

The controller 11 controls the image forming apparatus 10. As illustrated in FIG. 3, the controller 11 includes a central processing unit (CPU) 501, a read-only memory (ROM) 502, and a random-access memory (RAM) 503.

The image forming apparatus 100 includes an access memory (RAM) 503, an engine interface 504, an operation unit interface 505, a storage device 506, and a digital front end (DFE) interface 507.

The CPU 501 is an arithmetic device that controls the operation of the entire image forming apparatus 10. The ROM 502 is a nonvolatile storage device that stores a program for the image forming apparatus 10. The RAM 503 is a volatile storage device used as a work area of the CPU 501.

The engine interface 504 is an interface for controlling the image former 12.

The operation unit interface 505 is an interface for performing data communication with the operation unit 30, such as a touch panel, which is used to operate the image forming apparatus 10.

The storage device 506 is a storage device such as a hard disk drive (HDD) or a solid state drive (SSD) that stores various data, programs, and other information.

The DFE interface 507 is an interface for communicating with a DFE 20.

The CPU 501, the ROM 502, the RAM 503, and the engine interface 504, the operation unit interface 505, the storage device 506, and the DFE interface 507 are communicably connected to each other via a bus 510 such as an address bus and a data bus.

The image former 12 is a mechanism that forms a full-color image or a monochrome image on a recording medium. The image former 12 corresponds to, for example, an intermediate transfer belt 702, the photoconductor drum 703, and the transfer roller 704 illustrated in FIG. 1.

The hardware configuration of the image forming apparatus 10 is not limited to that illustrated in FIG. 3. The image forming apparatus 10 does not necessarily include all the components illustrated in FIG. 3 or may include some other components.

### Hardware Configuration of DFE

FIG. 4 is a diagram illustrating a hardware configuration of a digital front end (DFE) according to a first embodiment. The hardware configuration of the DFE 20 is described below with reference to FIG. 4.

The DFE 20 is an information processing apparatus (or an image processor) that performs raster image processor (RIP) processing to convert input print information into a format suitable for print processing in the image forming apparatus 10. In the present embodiment, the print data (or input data) is assumed not to include a special color plate, such as a silver plate. As illustrated in FIG. 4, the DFE 20 includes a CPU 601, a ROM 602, a RAM 603, an auxiliary storage device 605, a display 608, a controller I/F 609, and an input device 611.

The CPU 601 is an arithmetic device that controls the operation of the entire DFE 20. The ROM 602 is a nonvolatile storage device that stores a program for the DFE 20. The RAM 603 is a volatile storage device used as a working area of the CPU 601.

The auxiliary storage device 605 is a storage device such as an HDD or an SSD that stores various data, programs, and other information.

The display 608 is a display device including a liquid crystal and an organic electro-luminescence (EL) that display various information such as a cursor, a menu, a window, characters, or an image.

The controller I/F 609 is an interface for communicating with the controller 11 of the image forming apparatus 10.

The input device 611 is an input device used for selecting characters, numbers, or various commands, and for moving a cursor, for example.

The CPU 601, the ROM 602, the RAM 603, the auxiliary storage device 605, the display 608, the controller I/F 609, and the input device 611 are communicably connected to each other through a bus 610 such as an address bus or a data bus.

The hardware configuration of the DFE 20 is not limited to that illustrated in FIG. 4. The image forming apparatus 10 does not necessarily include all the components illustrated in FIG. 4 or may include some other components.

### Configuration and Operation of Functional Blocks of DFE

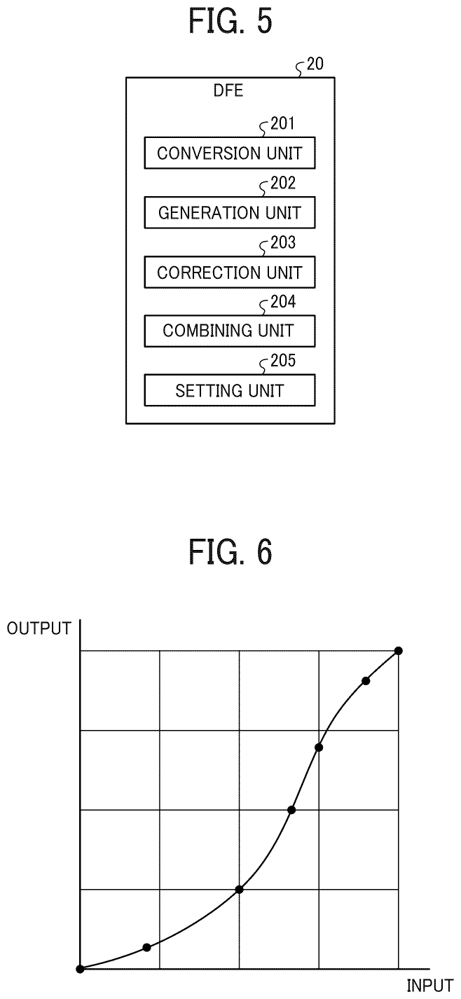

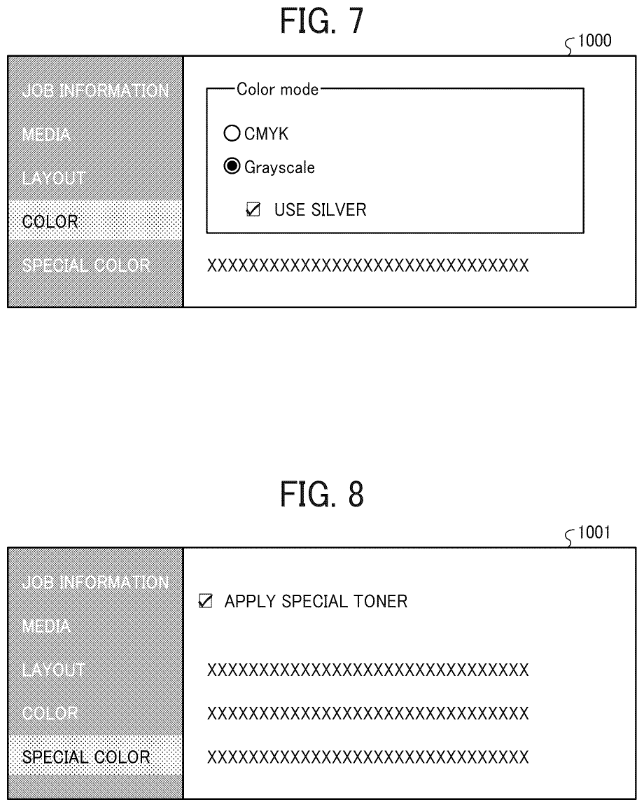

FIG. 5 is a diagram illustrating a functional configuration of the DFE according to the first embodiment. FIG. 6 is a diagram illustrating a tone reproduction curve (TRC) for gradation correction, used in the DFE. FIG. 7 is a diagram illustrating a setting screen of the DFE. FIG. 8 is a diagram illustrating a setting screen of the DFE. The configuration and operation of the functional blocks of the DFE 20 are described below with reference to FIGS. 5 to 8.

As illustrated in FIG. 5, the DFE 20 includes a conversion unit 201, a generation unit 202, a correction unit 203, a combining unit 204, and a setting unit 205.

The conversion unit 201 is a functional unit that converts print data (or input data) input from an external device into grayscale.

The generation unit 202 is a functional unit that, when the use of silver toner is set by the setting unit 205, copies the gradation value of the black plate from the grayscale data converted by the conversion unit 201 to the gradation value of the silver plate, generating gradation data for the silver plate.

That is, the generation unit 202 generates data of the gradation value of the silver plate based on the gradation value of the black plate of the input data converted into the gray scale by the conversion unit 201. Note that the process is not limited to simply copying the gradation value of the black plate to the gradation value of the silver plate; the gradation value of the silver plate after copying may also be further corrected.

The correction unit 203 is a functional unit that, when the use of silver toner is set by the setting unit 205, performs gradation correction on the gradation value of the black plate data in grayscale, which has been converted by the conversion unit 201, according to a prescribed TRC as illustrated in FIG. 6. In this case, the data of the TRC may be stored in the auxiliary storage device 605 illustrated in FIG. 4, for example.

The combining unit 204 combines the black plate data subjected to gradation correction performed by the correction unit 203 with the silver plate data generated by the generation unit 202, producing the output data for the black plate and silver plate (K+Silver plate). This enables silver to be used in highlight areas, and allows the gradation value of the black plate to be increased from around the middle gradation range, thus forming output data in which brightness changes linearly. That is, the output data is set so that the ratio of the gradation value of the black plate to the gradation value of the silver plate increases as the gradation value of the silver plate increases. In the combination of the black plate and the silver plate, the brightness decreases linearly and monotonically as the gradation increases, allowing glossiness brought by silver to be maximized.

In the image processing apparatus, the circuitry (e.g., the CPU 601) is further configured to correct gradation of the first gradation value of the black plate to generate black plate data having a third gradation value different from the first gradation value; and combine the black plate data and the special color plate data to generate the output data to be output to the image former.

The circuitry is further configured to output the output data to the image former to cause the image former to form the print image having a brightness monotonically decreasing as the second gradation value of the special color plate data increases.

The circuitry is further configured to increase a ratio of the third gradation value of the black plate data to the second gradation value of the special color plate data as the second gradation value of the special color plate data increases in the output data.

The circuitry is further configured to linearly and monotonically decreases the brightness of the print image as the second gradation value of the special color plate data increases.

The setting unit 205 is a functional unit that sets whether to use silver toner in accordance with an operation on the input device 611. The setting unit 205 causes the display 608 to display a setting screen 1000 as illustrated in FIG. 7, sets a color mode or a gray scale in accordance with an operation on the input device 611, and further sets whether to use silver when the gray scale is set. The setting unit 205 then stores the settings in the auxiliary storage device 605. To separately set a special color toner (or special toner), a setting screen 1001 as illustrated in FIG. 8 may be displayed to set whether to apply the special color toner.

The conversion unit 201, the generation unit 202, the correction unit 203, the combining unit 204, and the setting unit 205 as described above are implemented by the CPU 601 as illustrated in FIG. 5 executing a program.

At least a part of functional units implemented by software (program) among the functional units of the DFE 20 illustrated in FIG. 5 may be implemented by a hardware circuit such as a field-programmable gate array (FPGA) or an application specific integrated circuit (ASIC).

Each functional unit of the DFE 20 illustrated in FIG. 5 conceptually indicates a function, and is not limited to such a configuration. For example, multiple functional units that are independent from each other in FIG. 5 can be combined into one functional unit. In some examples, the function of one functional unit in the DFE 20 illustrated in FIG. 5 may be divided into multiple functions to serve as multiple functional units.

Further, the functional units of the DFE 20 illustrated in FIG. 5 are not limited to those in the DFE 20 as a separate unit from the image forming apparatus 10, and at least some of the functional units may also be incorporated into the image forming apparatus 10.

In some examples, an image forming apparatus 10 includes an image former 12 to form a print image on a medium; and circuitry (e.g., the CPU 601) configured to convert input data of a black plate into grayscale to obtain a first gradation value of the black plate; generate special color plate data having a second gradation value of a special color plate based on the first gradation value of the black plate; and control the image former to form the print image on the medium based on output data generated based on the special color plate data.

### Processing for Generating Output Data of K+Silver Plate of DFE

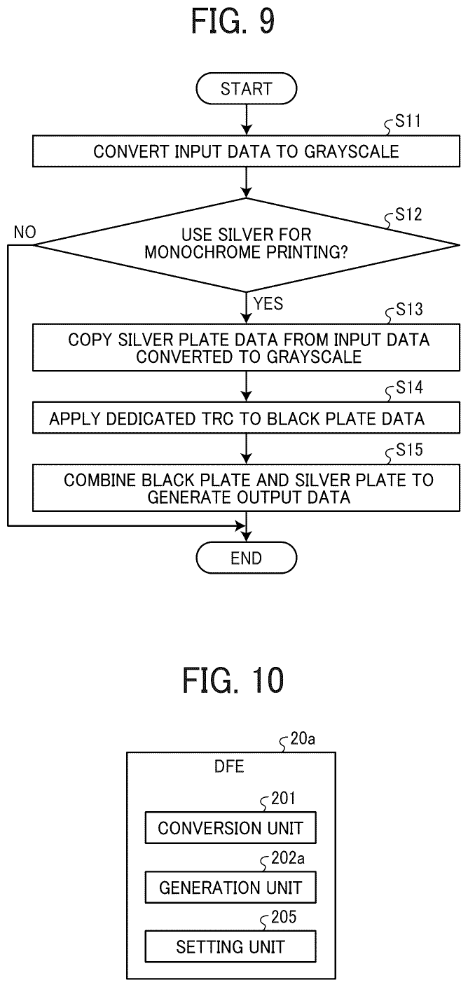

FIG. 9 is a diagram illustrating a process for generating output data for a K+silver plate of the DFE. The following describes processing for generating output data of K+silver plate of the DFE 20 with reference to FIG. 9.

### Step S11

The conversion unit 201 of the DFE 20 is a functional unit that converts print data (or input data) input from an external device into grayscale. Then, the process proceeds to step S12.

### Step S12

The CPU 601 determines whether the use of silver toner is set by the setting unit 205 in step S12. In other words, the CPU 601 (e.g., the circuitry) determines whether an input of using special color toner in the image former is received. Based on a determination that the use of silver toner is set by the setting unit 205 (YES in step S12), the process proceeds to step S13. In other words, the circuitry (e.g., the CPU 601) determines whether an input of using special color toner in the image former is received; and generate the special color plate data having the second gradation value based on the first gradation value of the black plate data in response to a receipt of the input. Based on a determination that the use of silver toner is not set by the setting unit 205 (NO in step S12), the process ends.

### Step S13

The generation unit 202 of the DFE 20 copies the gradation value of the black plate from the grayscale data converted by the conversion unit 201 to the gradation value of the silver plate, generating gradation data for the silver plate. Then, the process proceeds to step S14.

### Step S14

The correction unit 203 of the DFE 20 performs gradation correction on the gradation value of the black plate data in grayscale, which has been converted by the conversion unit 201, according to a prescribed TRC as illustrated in FIG. 6. Then, the process proceeds to step S15.

### Step S15

The combining unit 204 of the DFE 20 combines the black plate data subjected to gradation correction performed by the correction unit 203 with the silver plate data generated by the generation unit 202, producing the output data for the black plate and the silver plate (K+Silver plate). Then, the process ends.

An image processing apparatus includes circuitry (e.g., the CPU 601) configured to convert input data of a black plate into grayscale to obtain a first gradation value of the black plate; generate special color plate data having a second gradation value of a special color plate based on the first gradation value of the black plate; and output output data, generated based on the special color plate data, to an image former to form a print image on a medium.

As described above, the conversion unit 201 of the DFE 20 converts input data without a special color plate, such as a silver plate, into grayscale. The generation unit 202 then generates silver plate gradation data based on the gradation value of the black plate of the input data converted into the grayscale by the conversion unit 201. More specifically, the generation unit 202 copies the gradation value of the black plate of the input data converted into the grayscale by the conversion unit 201 to generate silver plate gradation data. The correction unit 203 performs gradation correction on the gradation value of the black plate of the input data converted into the grayscale by the conversion unit 201 according to a prescribed TRC. The combining unit 204 combines the black plate gradation data subjected to the gradation correction by the correction unit 203 and the silver plate gradation data generated by the generation unit 202 to generate output data for the black plate and the silver plate. This enables a desired glossy output using a silver plate in addition to a black plate without empirically adjusting the gradation of each color.

### Second Embodiment

A DFE according to a second embodiment is described below, focusing on the differences from the DFE 20 according to the first embodiment. In the present embodiment, an operation of generating output data of the K+silver plate using a lookup table (LUT) is described. The configuration of the image forming apparatus 10 according to the present embodiment and the hardware configuration of the image forming apparatus 10 and the DFE are the same as those described in the first embodiment.

### Configuration and Operation of Functional Blocks of DFE

FIG. 10 is a diagram illustrating a functional configuration of a DFE according to a second embodiment.

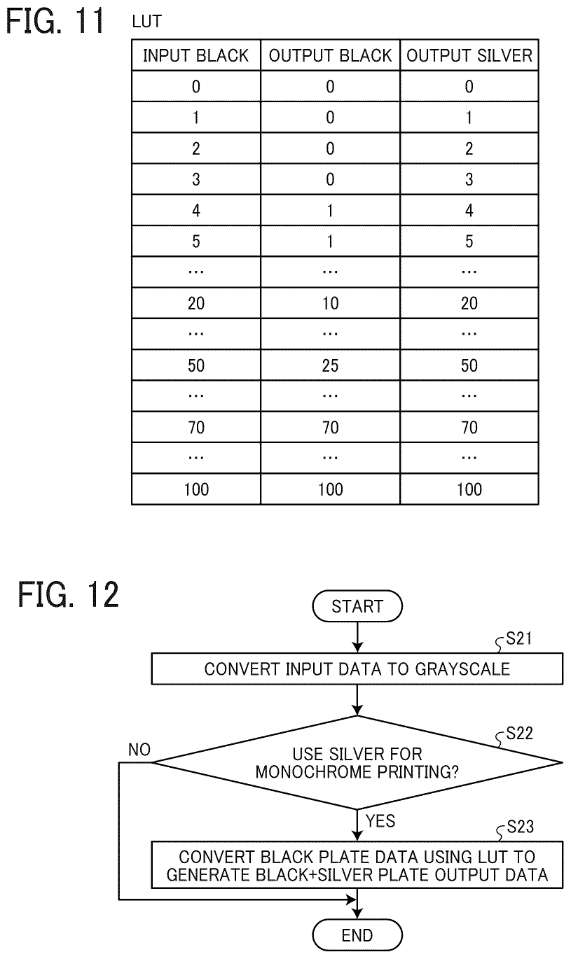

FIG. 11 is a diagram illustrating a lookup table (LUT) used in the DFE. The configuration and operation of functional blocks of a DFE 20a according to the present embodiment is described below with reference to FIGS. 10 and 11.

As illustrated in FIG. 10, the DFE 20a includes a conversion unit 201, a generation unit 202a, and a setting unit 205. The operations of the conversion unit 201 and the setting unit 205 are the same as those of the first embodiment.

The generation unit 202a is a functional unit that, when the use of silver toner is set by the setting unit 205, converts the gradation value of the black plate from the grayscale data converted by the conversion unit 201, into the gradation value for the K+silver plate, using the LUT as in FIG. 11. That is, the generation unit 202a generates data of the gradation value of the silver plate based on the gradation value of the black plate of the input data converted into the gray scale by the conversion unit 201. This enables silver to be used in highlight areas, and allows the gradation value of the black plate to be increased from around the middle gradation range, thus forming output data in which brightness changes linearly. That is, the output data is set so that the ratio of the gradation value of the black plate to the gradation value of the silver plate increases as the gradation value of the silver plate increases. In the combination of the black plate and the silver plate, the brightness decreases linearly and monotonically as the gradation increases, allowing glossiness brought by silver to be maximized.

The circuitry (e.g., the CPU 601) corrects gradation of the first gradation value of the black plate to generate the black plate data having the third gradation value, using a prescribed tone reproduction curve (TRC) or a prescribed lookup table (LUT).

The conversion unit 201, the generation unit 202a, and the setting unit 205 as described above are implemented by the CPU 601 as illustrated in FIG. 5 executing a program. At least a part of functional units implemented by software (program) among the functional units of the DFE 20a illustrated in FIG. 10 may be implemented by a hardware circuit such as an FPGA or an ASIC.

Each functional unit of the DFE 20a illustrated in FIG. 10 conceptually indicates a function, and is not limited to such a configuration. For example, multiple functional units that are independent from each other in the DFE 20a illustrated in FIG. 10 can be combined into one functional unit. In some examples, the function of one functional unit in the DFE 20a illustrated in FIG. 10 may be divided into multiple functions to serve as multiple functional units.

Further, the functional units of the DFE 20a illustrated in FIG. 10 are not limited to those in the DFE 20a as a separate unit from the image forming apparatus 10, and at least some of the functional units may also be incorporated into the image forming apparatus 10. Processing for Generating Output Data of K+Silver Plate of DFE

FIG. 12 is a diagram illustrating a process for generating output data for a K+silver plate of the DFE. The following describes processing for generating output data of K+silver plate of the DFE 20a with reference to FIG. 12.

### Step S21

The conversion unit 201 of the DFE 20a is a functional unit that converts print data (or input data) input from an external device into grayscale. Then, the process proceeds to step S22.

### Step S22

The CPU 601 determines whether the use of silver toner is set by the setting unit 205 in step S22. Based on a determination that the use of silver toner is set by the setting unit 205 (YES in step S22), the process proceeds to step S23. Based on a determination that the use of silver toner is not set by the setting unit 205 (NO in step S22), the process ends.

### Step S23

The generation unit 202a of the DFE 20a is a functional unit that, when the use of silver toner is set by the setting unit 205, converts the gradation value of the black plate from the grayscale data converted by the conversion unit 201, into the gradation value for the K+silver plate, using the LUT as in FIG. 11. Then, the process ends.

As described above, the generation unit 202a of the DFE 20a generates output data by converting the black plate gradation value of the input data, which has been converted into grayscale by the conversion unit 201, into gradation values for the black plate and the silver plate using a prescribed LUT. This enables a desired glossy output using a silver plate in addition to a black plate without empirically adjusting the gradation of each color.

The operation described in the above embodiments focuses on monochrome image printing, but the operation may also be applied to full-color image printing. When a full-color image is printed, the image data is converted into CMYK data through color matching using an International Color Consortium (ICC) profile. The operations described in the above embodiments may be applied to the converted black plate data to generate K+silver plate output data.

The circuitry (e.g., the CPU 601) converts input data of a color plate into the input data of the black plate to obtain the first gradation value of the black plate.

In each of the embodiments described above, when at least one of the functional units of cach of the DFEs 20 and 20a is implemented by a program executed by the CPU, such program may be installed in a ROM or any desired memory of the information processing apparatus in advance. Alternatively, the computer program executed in the DFEs 20 and 20a according to the above-described embodiments can be provided as a file in an installable format or an executable format and stored in a computer-readable recording medium, such as a compact disc read only memory (CD-ROM), a flexible disk (FD), a compact disc recordable (CD-R), and a digital versatile disk (DVD). Further, the program executed by the DFEs 20 and 20a according to the above-described embodiments may be stored on a computer connected to a network such as the Internet, to be downloaded via the network. Further, the computer program executed in the DFEs 20 and 20a according the above-described embodiments may be provided or distributed via a network such as the Internet. A program to be executed by the DFEs 20 and 20a according to the above-described embodiments has module structure including at least one of the above-described functional units. Regarding the actual hardware related to the program, the CPU 601 reads and executes the program from the memory (e.g., the ROM 602 or the auxiliary storage device 605) to load the program onto the main memory (the RAM 603) to implement the above-described functional units.

Aspects of the present disclosure are as follows.
Aspect 1
   An image processing apparatus includes circuitry configured to convert input data of a plate without a special color plate into grayscale to obtain a first gradation value of a black plate, the special color plate being a plate excluding the black plate, a magenta plate, a cyan plate, and a yellow plate; generate special color plate data having a second gradation value of the special color plate based on the first gradation value of the black plate; and output output data, generated based on the special color plate data, to an image former to form a print image on a medium.
Aspect 2
   In the image processing apparatus according to Aspect 1, the circuitry is further configured to correct gradation of the first gradation value of the black plate to generate black plate data having a third gradation value different from the first gradation value; and combine the black plate data and the special color plate data to generate the output data to be output to the image former.
Aspect 3
   In the image processing apparatus according to Aspect 1 or 2, the circuitry is further configured to output the output data to the image former to cause the image former to form the print image having a brightness monotonically decreasing as the second gradation value of the special color plate data increases.
Aspect 4
   In the image processing apparatus according to Aspect 3, the circuitry is further configured to increase a ratio of the third gradation value of the black plate data to the second gradation value of the special color plate data as the second gradation value of the special color plate data increases in the output data.
Aspect 5
   In the image processing apparatus according to Aspect 3, the circuitry is further configured to linearly and monotonically decreases the brightness of the print image as the second gradation value of the special color plate data increases.
Aspect 6
   In the image processing apparatus according to Aspect 2, the circuitry is further configured to correct gradation of the first gradation value of the black plate to generate the black plate data having the third gradation value, using a prescribed tone reproduction curve (TRC) or a prescribed lookup table (LUT).
Aspect 7
   In the image processing apparatus according to Aspect 1, the circuitry is further configured to: determine whether an input of using special color toner in the image former is received; and generate the special color plate data having the second gradation value based on the first gradation value of the black plate data in response to a receipt of the input.
Aspect 8
   In the image processing apparatus according to Aspect 1, the circuitry is further configured to convert input data of a color plate into the input data of the black plate to obtain the first gradation value of the black plate.
Aspect 9
   An image forming apparatus includes an image former to form a print image on a medium; and circuitry configured to convert input data of a plate without a special color plate into grayscale to obtain a first gradation value of a black plate, the special color plate being a plate excluding the black plate, a magenta plate, a cyan plate, and a yellow plate; generate special color plate data having a second gradation value of the special color plate based on the first gradation value of the black plate; and control the image former to form the print image on the medium based on output data generated based on the special color plate data.
Aspect 10
   An image processing method includes converting input data of a plate without a special color plate into grayscale to obtain a first gradation value of a black plate, the special color plate being a plate excluding the black plate, a magenta plate, a cyan plate, and a yellow plate; generating special color plate data having a second gradation value of the special color plate based on the first gradation value of the black plate; and outputting output data, generated based on the special color plate data, to an image former to form a print image on a medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processing apparatus comprising circuitry configured to:
convert input data of a plate without a special color plate into grayscale to obtain a first gradation value of a black plate, the special color plate being a plate excluding the black plate, a magenta plate, a cyan plate, and a yellow plate;
generate special color plate data having a second gradation value of the special color plate based on the first gradation value of the black plate; and
output output data, generated based on the special color plate data, to an image former to form a print image on a medium.

2. The image processing apparatus according to claim 1,
wherein the circuitry is further configured to:
correct gradation of the first gradation value of the black plate to generate black plate data having a third gradation value different from the first gradation value; and
combine the black plate data and the special color plate data to generate the output data to be output to the image former.

3. The image processing apparatus according to claim 1,
wherein the circuitry is further configured to output the output data to the image former to cause the image former to form the print image having a brightness monotonically decreasing as the second gradation value of the special color plate data increases.

4. The image processing apparatus according to claim 3,
wherein the circuitry is further configured to increase a ratio of the third gradation value of the black plate data to the second gradation value of the special color plate data as the second gradation value of the special color plate data increases in the output data.

5. The image processing apparatus according to claim 3,
wherein the circuitry is further configured to linearly and monotonically decreases the brightness of the print image as the second gradation value of the special color plate data increases.

6. The image processing apparatus according to claim 2,
wherein the circuitry is further configured to correct gradation of the first gradation value of the black plate to generate the black plate data having the third gradation value, using a prescribed tone reproduction curve (TRC) or a prescribed lookup table (LUT).

7. The image processing apparatus according to claim 1,
wherein the circuitry is further configured to:
determine whether an input of using special color toner in the image former is received; and
generate the special color plate data having the second gradation value based on the first gradation value of the black plate data in response to a receipt of the input.

8. The image processing apparatus according to claim 1,
wherein the circuitry is further configured to convert input data of a color plate into the input data of the black plate to obtain the first gradation value of the black plate.

9. An image forming apparatus comprising:
an image former to form a print image on a medium; and
circuitry configured to:
convert input data of a plate without a special color plate into grayscale to obtain a first gradation value of a black plate, the special color plate being a plate excluding the black plate, a magenta plate, a cyan plate, and a yellow plate;
generate special color plate data having a second gradation value of the special color plate based on the first gradation value of the black plate; and
control the image former to form the print image on the medium based on output data generated based on the special color plate data.

10. An image processing method comprising:
converting input data of a plate without a special color plate into grayscale to obtain a first gradation value of a black plate, the special color plate being a plate excluding the black plate, a magenta plate, a cyan plate, and a yellow plate;
generating special color plate data having a second gradation value of the special color plate based on the first gradation value of the black plate; and
outputting output data, generated based on the special color plate data, to an image former to form a print image on a medium.
